(19) United States
(12) Patent Application Publication
(10) Pub. No.: US 2013/0173478 A1
(43) Pub. Date: Jul. 4, 2013

(54) SYSTEM AND METHOD FOR A CONSUMER TO MERCHANT NEGOTIATION

(71) Applicant: Amir M. Farhi, Newton Upper Falls, MA (US)

(72) Inventor: Amir M. Farhi, Newton Upper Falls, MA (US)

(73) Assignee: NETOTIATE, INC., Newton Upper Falls, MA (US)

(21) Appl. No.: 13/420,048

(22) Filed: Mar. 14, 2012

Related U.S. Application Data
(60) Provisional application No. 61/581,304, filed on Dec. 29, 2011.

(51) Int. Cl. G06Q 30/00

(52) U.S. Cl. 705/80

(57) ABSTRACT

A method for a consumer-to-merchant electronic negotiation. The method comprises receiving a time-limited initial binding offer from the consumer for purchasing at least one product from at least one merchant of choice; determining whether the initial offer made by the consumer is valid; notifying the least one merchant about the initial offer from the consumer with respect of the merchant without revealing consumer information; receiving from the merchant a time-limited response respective of the initial offer, the time-limited response is one of an acceptance of the initial offer, a decline of the initial offer, and one or more time-limited counter-offers; and processing the time-limited response received from the merchant to determine at least if the consumer-to-merchant negotiation has not been concluded.

### CROSS REFERENCE TO RELATED APPLICATIONS

This application claims the benefit of U.S. provisional application No. 61/581,304 filed on Dec. 29, 2011, the contents of which are herein incorporated by reference.

### TECHNICAL FIELD

The invention generally relates to a computerized negotiation platform for electronic commerce (E-commerce) websites, and more specifically to anonymous negotiation platforms between consumers and merchants.

### BACKGROUND OF THE INVENTION

The way people shop has significantly progressed since the development of the worldwide web (WWW). Consumers can now shop from the convenience of their home, office, or while on the road using portable devices. Popular on-line shopping websites, such as Amazon.com®, allow consumers to purchase goods directly through the website. From a merchant's point of view, such websites allow access to a worldwide market of consumers.

The services provided by websites, such as Shopping.com, PriceGrabber.com, Nextag and a few others, belong to a category of web sites that provide comparison shopping engines (CSE) that assist consumers by presenting prices and information about a product the consumer may be interested in purchasing. In response to a consumer's query, the consumer is provided with a list of possibilities based on characteristics such as price and popularity. The CSE is generally considered to be an effective tool for consumers.

As another example, Priceline.com® allows a consumer to make a bid for a traveling service, such as a hotel room reservation. In response the service provider (e.g., either Priceline.com or the hotel), can either accept or reject that bid. In response, the consumer can either search for another alternative or raise the bid until it is accepted by the service provider. The disadvantage of such an approach is that the consumer does not know the particulars of the vendor or service provider. For example, the consumer selects the area and level of a hotel he/she desires to stay at, but the consumer cannot bid on a specific hotel. Further, all bids placed by the consumer are binding and now true negotiation take place.

It would therefore be advantageous to overcome the limitations of the prior art by providing an effective way for a consumer and a supplier to negotiate. It would be further advantageous to the consumer if such negotiation would be anonymous by nature.

### SUMMARY OF THE INVENTION

Certain embodiments of the invention disclosed herein include a method for a consumer-to-merchant negotiation. The method comprises receiving a time-limited initial offer from the consumer for purchasing at least one product of choice from at least one merchant of choice, wherein the initial offer includes at least an offered price for the product of choice, the at least one merchant of choice, and the product of choice, wherein the initial offer expires after a predefined timeframe; determining whether the initial offer made by the consumer is valid; notifying the least one merchant of choice about the initial offer from the consumer with respect of the at least one product of choice without revealing consumer information; receiving from the merchant of choice a time-limited response respective of the initial offer, the time-limited response is one of an acceptance of the initial offer, a decline of the initial offer, and one or more time-limited counter-offers; and, processing the time-limited response received from the at least one merchant of choice to determine at least if the consumer-to-merchant negotiation has not been concluded.

Certain embodiments of the invention disclosed herein also include a system for a consumer to merchant negotiation. The system comprises a consumer device configured to generate a time-limited initial offer for purchasing at least one product of choice from at least one merchant of choice, wherein the initial offer includes at least an offered price for the product of choice, the at least one merchant of choice, and the product of choice, wherein the initial offer expires after a predefined timeframe; a mediatorial server including at least a processing unit and configured to receive the initial offer, to determine whether the initial offer made by the consumer is valid, and to notify the at least one merchant of choice about the initial offer from the consumer with respect of the at least one product of choice without revealing consumer information; and a merchant device of a merchant of choice configured to generate at least a time-limited response respective of the initial offer, the content of the time-limited response includes one of an acceptance of the initial offer, a decline of the initial offer, and one or more time-limited counter-offers; wherein the mediatorial server is further configured to process the time-limited response generated by the merchant device to determine if the consumer to merchant negotiation has not been concluded.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system in accordance with an embodiment of the invention;

FIGS. 2A-B are flowcharts describing the operation of the system in accordance with an embodiment of the invention; and

FIG. 3 is a flowchart describing a process of receiving the response from a merchant in accordance with an embodiment of the invention.

### DETAILED DESCRIPTION OF THE INVENTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The various exemplary embodiments discussed herein enable consumer-to-merchant negotiation of a business transaction. The consumer identifies a product to purchase and initiates an offer to purchase the product at a price of choice from a merchant of choice. In an embodiment, the consumer is allowed to make a single offer with respect of each single product to a specific merchant, and multiple offers to multiple merchants for the same product, which cannot be repeated until a response from the merchant is received, or has otherwise expired. Each offer is preferably anonymous and binding. The merchant is notified of the offer, preferably anonymously. The merchant can then accept the offer as is, decline the offer, or provide one or more counter offers, all within a limited time frame from receipt of the offer. Throughout the process respective data is saved into a database, for ranking the consumer and the merchant based on the transaction data.

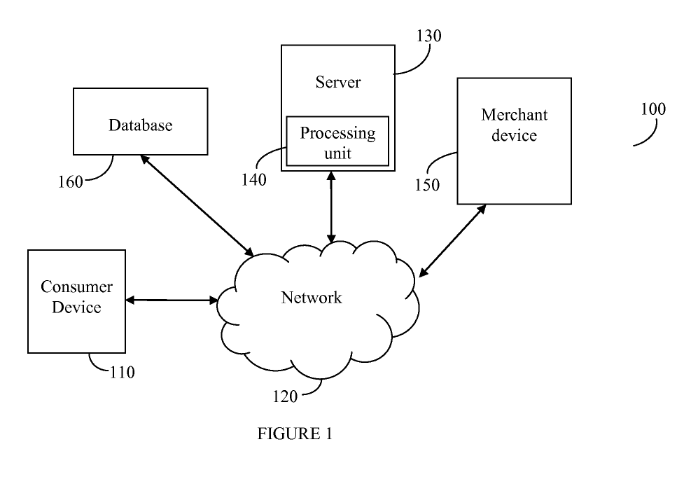

FIG. 1 depicts an exemplary and non-limiting schematic diagram of a system 100 utilized to describe various embodiments of the invention. Accordingly, a consumer by means of a consumer device 110, such as but not limited to, a personal computer (PC), a laptop computer, a mobile device, etc., is connected to a network 120. The network 120 can be wired or wireless, a local area network (LAN), a wide area network (WAN), a metro area network (MAN), the Internet, the worldwide web (WWW), the like, and any combinations thereof.

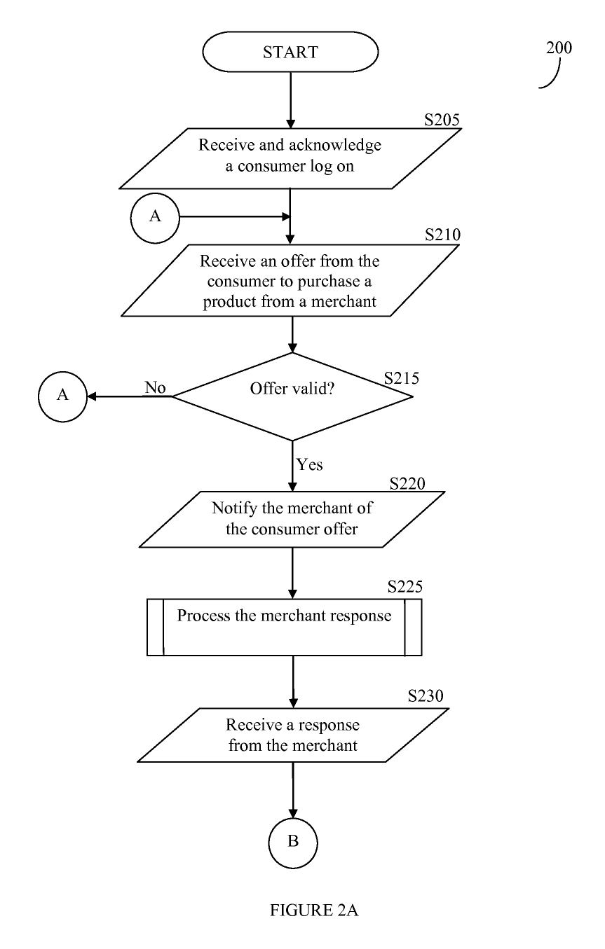

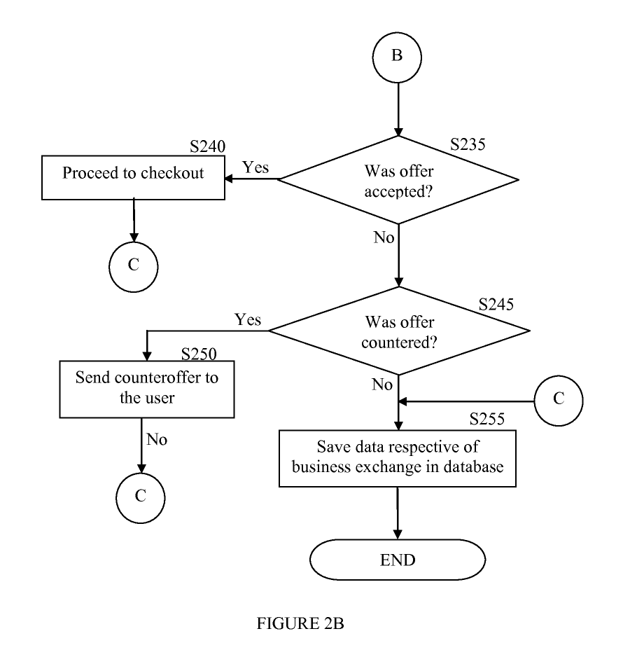

By communication from the consumer device 110, the consumer can communicate with a mediatorial server 130 for the purpose of making an offer for a product and as further explained herein below with respect of FIG. 2. The offer, which is binding upon the consumer, is then transferred, preferably anonymously, i.e., without the consumer's identifying information, to the merchant's device 150, from which the consumer desires to make the purchase. The merchant device may be one of a server, a personal computer, a smart phone, a mobile device, and the like.

It should be further noted that certain processing takes related to the merchant can be performed by the merchant's device 150 in conjunction with an engine (not shown) operative on the mediatorial server 130. For example, the merchant can configure the engine to respond either autonomously or responsive to inputs provided from the merchant device 150. As another example, the engine operative on the server 130 can automatically generate decline or acceptance messages based on a predetermined threshold of the declining/acceptance conditions set by the merchant. By using the engine operative on the mediatorial server 130, the merchant is able to predetermine the declining or acceptance conditions, thus when a counter offer is made the system automatically declines or accepts the counter offer based on the merchant determinations.

In one embodiment, the mediatorial server 130 checks the offer made by the consumer and validates that it is in fact a valid offer. A valid offer is an offer that was checked for consistency, was not provided to the server 130 within a forbidden timeframe, or was otherwise provided within an allowed timeframe where for example, the consumer is identified as having a valid form of payment that is consistent with the offer made, and so on and so forth. The merchant may respond via the server 130 of acceptance, rejection or counter offer to the offer made by the consumer.

All data with respect of the entire transaction between the consumer and the merchant is saved in the database 160. The withholding of the consumer information from the merchant can be kept indefinitely, until the offer is accepted by the merchant or until a counteroffer is accepted by the consumer. It should be noted that a server, such as the server 130, typically comprises a processing unit, such as a processor 140 that is coupled to a memory 145 (not shown). The memory contains instructions that when executed by the processor 140 results in the performance of the methods discussed herein.

FIGS. 2A and 2B depict an exemplary and non-limiting flowchart 200 describing a method of consumer-to-merchant negotiation of a business transaction in accordance with an embodiment of the invention. The method will be described with a reference to the system 100 shown in FIG. 1.

Referring now to FIG. 2A, in S205 a server, for example the server 130, receives and acknowledges a log on or identification of a consumer by means of a consumer device, for example consumer device 110. In S210, the server 130 receives an offer from the consumer to purchase a specific product from a specific merchant as selected by the consumer. The consumer is allowed to make a single offer for a single product to a specific merchant. The consumer may remain anonymous to the merchant and the offer is provided uniquely to the merchant selected by the consumer. In another embodiment, the consumer is allowed to make multiple offers for a single product provided by multiple merchants. An offer typically includes at least the product and the price the consumer wishes to pay. The offer is also submitted with the consumer's selected merchant or merchants.

In S215 it is checked whether the offer received by the consumer is valid, if so, execution continues with S220; otherwise, execution terminates (see FIG. 2B). In one embodiment, the consumer can change the offer a predetermined number of times if the offer was found invalid. The determination whether the offer is valid is based on criteria provided to the server by the merchant.

In S220, the server 130 notifies the merchant of the consumer offer. In response, the merchant, by means of, e.g., the merchant device 150, generates a response with respect of the consumer offer. The response may include, for example, a message indicating that the consumer's offer is accepted, rejected, or that the merchant wishes to counter the consumer offer. It should be noted that such a response may be automatic, based on an agent operative on the merchant's device 150, or manually entered by the merchant responsive of receiving a notification of a pending offer.

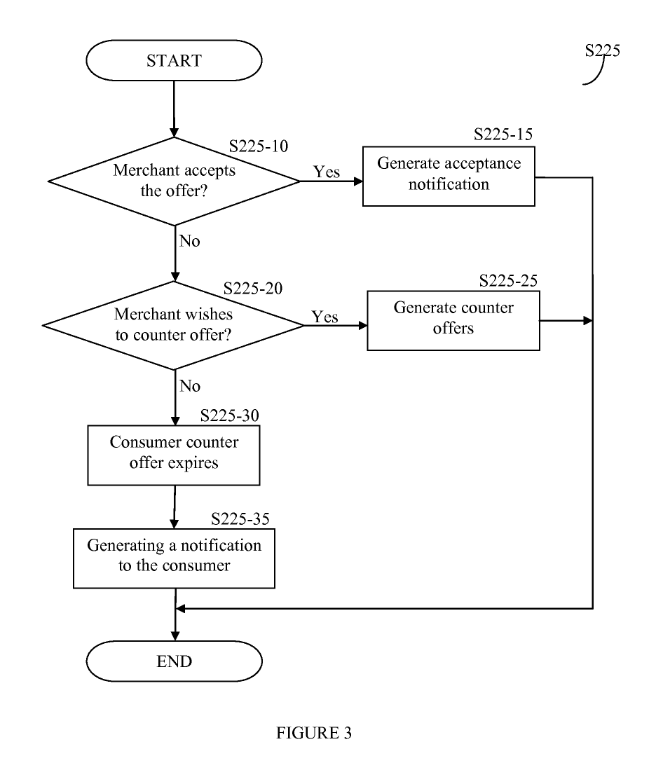

In S222, the response from the merchant is received. The merchant has a limited timeframe to respond to the consumer offer and if the response diverges from the timeframe, the response is discarded. This limited timeframe of the consumer offer may be a default value set by the server 130, or a value that is set by the consumer or by the server 130 as part of the process of making an offer. In the latter case it is possible that the validity of the offer will include checking that the timeframe set by the consumer is consistent with merchant requirements as well as, or alternatively, the server 130 requirements. In S225, the merchant response is processed by the server 130 as described in detail in FIG. 3. The output of the response processing is an acceptance notification indicating the consumer offer has been accepted, a decline notification indicating that the consumer offer has been declined, or a counteroffer generated for the consumer. In S230, the response from the merchant is received.

Referring now to FIG. 2B, in S235, it is checked whether the consumer offer was accepted, and if so execution continues with S240; otherwise execution continues with S245. In S240, the execution continues to the checkout where the server 130 causes execution of a billing transaction which includes the charging of the consumer for the product for which the consumer made an offer. In an embodiment, offers made by the consumer are binding and as such include billing information.

In S245, it is checked whether one or more counteroffers for the consumer was generated, if so, execution continues with S250, where the one or more counteroffers is sent to the consumer; otherwise, execution continues with S255. It should be noted that if a counter offer is made, the consumer may or may not accept one of the time-limited counter offers. In one embodiment, if the consumer wishes to counter the merchant offer, then the process is similar to that of a new transaction, potentially without the need for the identification step S205. Anonymity of the consumer with respect of the merchant may be maintained indefinitely or until at least an offer or counter offer are accepted. In S255 all data respective of the consumer/merchant interaction is saved in database 160.

In one embodiment, both the consumer and the merchant receive a score based on respective current and past transactions using the system 100 and each have a personal scorecard displaying their score and relative ranking. Based on scores and ranks, the server 130 can better match between a consumer and a merchant. For example, when a consumer wishes to purchase a camera, the system may suggest one or more merchants that are willing to negotiate the price of the camera and may further have a ranking that is desirable for the user. In another example, the system can generate a recommendation of a highly ranked consumer to a merchant when the high ranked consumer makes an offer. This is important information to the merchant that may wish to close a deal with a consumer known to be a serious buyer. Thus, the server 130 using the computed score and ranking, can populate a list of merchants that best fit the consumers' preferences or provide indications to both to enable merchant and consumer to enable to better deals.

FIG. 3 depicts an exemplary and non-limiting flowchart of the process of generating the response by a merchant in S225 based on an offer received from the consumer through the server 130 in accordance with an embodiment. In S225-10, it is checked whether the merchant accepts the offer received from the consumer and if so, execution continues with S225-15 where an acceptance notification is generated after which execution of S225 terminates; otherwise, execution continues with S225-20. In S225-20 it is checked whether the merchant wishes to counter the offer and if so, execution continues with S225-25; otherwise, execution continues with S225-30. In S225-25, the server 130 receives from the merchant one or more time-limited counteroffers.

A counteroffer may include, but is not limited to, a price suggested by the merchant, a similar product to the product that the consumer requested to purchase, one or more additional products of the same kind or different, a discount coupon, or any combination thereof. In one embodiment, the server 130 may be configured with a plurality of rules to generate a counteroffer on behalf of the merchant. The plurality of rules may include a price range for a product, the current inventory level of the product, a specific promotion offered by the merchant for the product, similar products that may be of interest to the consumer, and so on. The server 130 may generate a counteroffer based on one or more of the configured rules. The rules may be dynamically updated by the merchant respective of pending offers from the consumer. For example, if the merchant wishes to clear the inventory of the certain product, the merchant may reduce the minimum price of the product even if no offer has been received. It should be appreciated that the server 130 may also autonomously decide if to accept or decline a consumer offer based on such rules.

In one embodiment, the examination of the offer received by the consumer is made automatically by the merchant device 150 based on predetermined preferences determined by the merchant. In S225-30, the consumer offer expires and in S225-35, a notification is generated and sent to the consumer after which execution terminates.

The various embodiments of the invention are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for a consumer-to-merchant electronic negotiation, comprising:
receiving a time-limited initial binding offer from the consumer for purchasing at least one product of choice from at least one merchant of choice, wherein the initial offer includes at least an offered price for the product of choice, the at least one merchant of choice, and the product of choice, wherein the initial offer expires after a predefined timeframe;
determining whether the initial offer made by the consumer is valid;
notifying the least one merchant of choice about the initial offer from the consumer with respect of the at least one product of choice without revealing consumer information;
receiving from the merchant of choice a time-limited response respective of the initial offer, the time-limited response is one of an acceptance of the initial offer, a decline of the initial offer, and one or more time-limited counter-offers; and
processing the time-limited response received from the at least one merchant of choice to determine at least if the consumer-to-merchant negotiation has not been concluded.

2. The method of claim 1, further comprises:
receiving at least one subsequent time-limited offer from the consumer for the at least one product of choice; and
processing the at least one subsequent time-limited offer until the consumer-to-merchant negotiation is concluded.

3. The method of claim 1, further comprises:
receiving and acknowledging a consumer log on; and
receiving a selection of a merchant of choice and a product of choice from a consumer device of the consumer.

4. The method of claim 3, further comprises:
providing the consumer with a list of potential merchants for a product of choice.

5. The method of claim 4, further comprises:
providing the consumer with a list of potential merchants for a product of choice.

6. The method of claim 5, further comprises:
creating a personal score card for each merchant and consumer;
ranking the consumer and the merchant based on their past activities and a feedback received from the each merchant and consumer with respect of their interaction; and
presenting the rank of the consumer and the merchant in the consumer and the merchant personal score cards.

7. The method of claim 5, further comprising:
matching between a merchant and a consumer based on at least one of: a score card and a rank.

8. The method of claim 1, wherein the initial offer further includes billing information of the consumer, wherein the at least one subsequent offer includes a revised offered price, wherein each of the initial offer and the at least one subsequent offer is binding upon acceptance by the merchant.

9. The method of claim 1, wherein processing of the time-limited response received from the merchant of choice, further comprises:
checking at least the content of the time-limited response;
causing to a completion of a purchase transaction and concluding the negotiation, if the content of the time-limited response is an acceptance of the initial offer;
concluding the negotiation, if the content of the time-limited response is the decline of the initial offer; and
providing the consumer device with the merchant one or more time-limited counter-offers, if the content of the time-limited response is a merchant time-limited counter-offer, wherein the merchant time-limited counter-offer expires after a predefined timeframe.

10. The method of claim 9, wherein the merchant time-limited counter-offer includes at least one of: a counter price for the product of choice, a discount coupon, at least an additional product of choice, at least one additional other product, and a product similar to the product of choice.

11. The method of claim 10, wherein the product similar to the product of choice is counter offered in a price range of the initial offer for the product of choice.

12. The method of claim 1, wherein processing of at least one subsequent offer includes at least:
notifying the least one merchant of choice about the at least one subsequent offer from the consumer, wherein at least one subsequent offer expires after a predefined timeframe;
receiving from the merchant of choice a subsequent time-limited response respective of the at least one subsequent offer, the time-limited subsequent response includes any one of an acceptance of the initial offer, a decline of the initial offer, and a time-limited counter-offer; and
processing the subsequent response received from the merchant of choice to determine at least if the negotiation has been concluded.

13. The method of claim 12, wherein a number of the at least one subsequent offer is limited.

14. The method of claim 8, wherein examining whether the initial offer is valid further includes at least one of:
checking if the offered price is within a predefined price range for the product of choice; and
checking if the billing information is corrected.

15. The method of claim 1, further comprises:
saving in a database information respective of all offers exchanged between the consumer and the merchant during the consumer to merchant negotiation.

16. The method of claim 8, wherein the consumer information includes the billing information and any information identifying the consumer, wherein the consumer information is withheld from the merchant as long as the initial offer and the at least one subsequent offer have not been accepted.

17. A non-transitory computer readable medium having stored thereon instructions for causing one or more processing units to execute the method according to claim 1.

18. A system for a consumer to merchant negotiation, comprising:
a consumer device configured to generate a time-limited initial offer for purchasing at least one product of choice from at least one merchant of choice, wherein the initial offer includes at least an offered price for the product of choice, the at least one merchant of choice, and the product of choice, wherein the initial offer expires after a predefined timeframe;
a mediatorial server including at least a processing unit and configured to receive the initial offer, to determine whether the initial offer made by the consumer is valid, and to notify the at least one merchant of choice about the initial offer from the consumer with respect of the at least one product of choice without revealing consumer information; and
a merchant device of a merchant of choice configured to generate at least a time-limited response respective of the initial offer, the content of the time-limited response includes one of an acceptance of the initial offer, a decline of the initial offer, and a time-limited counter-offer; and
wherein the mediatorial server is further configured to process the time-limited response generated by the merchant device to determine if the consumer to merchant negotiation has not been concluded.

19. The system of claim 18, wherein the mediatorial server is further configured to receive at least one subsequent time-limited offer from the consumer device for the at least one product of choice; and process the at least one subsequent time-limited offer until the consumer to merchant negotiation has been concluded.

20. The system of claim 18, wherein the consumer device, the mediatorial server, and the merchant device are connected to a network.
